(19) United States
(12) Patent Application Publication
(10) Pub. No.: US 2014/0306636 A1
(43) Pub. Date: Oct. 16, 2014

(54) FAN CONTROL SYSTEM

(71) Applicant: Steven YU, Los Angeles, CA (US)

(72) Inventor: Steven YU, Los Angeles, CA (US)

(21) Appl. No.: 13/862,209

(22) Filed: Apr. 12, 2013

(51) Int. Cl. H02P 31/00

(52) U.S. Cl. CPC H02P 31/00
USPC 318/494

(57) ABSTRACT

A fan control system includes a fan and a portable mobile device. The fan includes a housing member; a driving motor mounted in the housing member and having a rotary shaft; a fan blade assembly assembled to the rotary shaft of the driving motor; and a command receiving control unit mounted in the housing member and electrically connected to the driving motor. The portable mobile device includes a touch panel forming an operation control interface, and internally has a transmission unit and a processor electrically connected to the touch panel and the transmission unit. When the operation control interface is touched, the processor receives an operation control signal and correspondingly generates a control command that is wirelessly transmitted to the command receiving control unit in the fan via the transmission unit, so that the fan is directly controllable via the portable mobile device and has largely increased practicality and usability.

### FIELD OF THE INVENTION

The present invention relates to a fan with oscillating unit, and more particularly to an oscillating fan that can be wirelessly controlled with a portable mobile device to operate.

### BACKGROUND OF THE INVENTION

An electric fan usually includes a fan blade assembly having blades with a curved configuration each. The fan blade assembly is driven by a driving motor to rotate, so that air is sucked into the fan from one side of the blades and then blown out of the fan from the other side of the blades to thereby produce airflow toward a target object. However, the blades can only produce linearly moved airflow. To direct the linearly moved airflow produced by the fan to different directions, an oscillating mechanism must be additionally provided for the fan.

According to the oscillating mechanisms thereof, the currently available fans can be generally divided into two types, namely, a cover-rotating fan and an oscillating fan.

The cover-rotating fan includes an air guiding mechanism arranged at a front side of the overall fan structure. The air guiding mechanism normally includes a plurality of parallelly spaced tilted slats. When the air guiding mechanism is rotated, the originally linearly moved airflow produced by the fan meets the rotating tilted slats and is automatically directed to different flowing directions to thereby produce a widened breezy area.

The oscillating fan is a fan provided in a base thereof with a rotary mechanism for producing an oscillating motion of the fan. That is, the rotary mechanism reciprocatingly rotates a main shaft of the fan to thereby change the direction of the produced airflow. When the oscillating fan operates, the whole fan oscillates about the rotary mechanism to swing to and fro sidewardly within a large span.

Both the cover-rotating fan and the oscillating fan use a motor as their power source. To regulate the fan motor's rotational speed, a user has to manipulate a control switch or turn a control knob on the fan to change an input impedance of the fan, so as to change the electric current input to the fan motor and accordingly, increase or decrease the volume and speed of air flow output from the fan.

The conventionally designed fan control structure allows the user to change the air volume and speed of the fan by manipulating the control switch or turning the control knob. However, it is possible the fan is positioned on a relatively high place or mounted on a ceiling and the control switch or the control knob is out of the user's reach. In this case, a pull-cord switch hung from the fan or a wired control unit at a remote location from the fan is usually provided for the user to control the fan. However, the pull-cord switch and the wired remote control unit might not allow the user to conveniently and quickly control the fan when the fan is mounted on some special position for some particular purpose. Therefore, it is desirable to provide a further improved control system for an overall control of a fan.

### SUMMARY OF THE INVENTION

A primary object of the present invention is to provide a fan control system, which includes a fan and a portable mobile device wirelessly linkable to the fan for controlling the operation of the fan, so that a user may directly control the fan via the wireless linking function of the portable mobile device even if the fan is mounted on a place that could not be easily accessed. As a result, the fan has largely increased practicality and usability.

To achieve the above and other objects, the fan control system according to the present invention includes a fan and a portable mobile device. The fan has a housing member; a driving motor mounted inside the housing member and having a forward extended rotary shaft projected from a front outer side of the housing member; a fan blade assembly assembled to the rotary shaft of the driving motor; and a command receiving control unit mounted inside the housing member and electrically connected to the driving motor. The portable mobile device is provided on a surface with a touch panel, which forms an operation control interface, and is internally provided with a processor and a transmission unit wirelessly linkable to the command receiving control unit. The processor has a control module and is electrically connected to the touch panel and the transmission unit.

The operation control interface produces an operation control signal when being touched by a user; and the processor receives the operation control signal and correspondingly generates a control command to the transmission unit, from where the control command is wirelessly transmitted to the command receiving control unit in the fan. The transmission unit and the command receiving control unit can link to each other via a wireless communication protocol, such as Bluetooth, Wi-Fi or WIMAX.

According to a preferred embodiment of the present invention, the fan further includes an oscillating unit mounted inside the housing member and electrically connected to the command receiving control unit for driving the housing member, the driving motor and the fan blade assembly to oscillate as a whole unit; a hood structure fixedly connected to the front outer side of the housing member and internally defining a forward protruded oscillating space, in which the fan blade assembly is located; and a heater provided in the oscillating space and electrically connected to the command receiving control unit.

In the present invention, the control module selectively enables the operation control interface to show one of an actuation icon before actuation and an operation page after actuation. On the operation page, there are shown at least an air speed regulation switch for actuating the driving motor to operate and an oscillation control switch for driving the oscillating unit to oscillate while operating.

The operation page further has a time switch shown thereon for turning on or off the driving motor, and the command receiving control unit in the fan is correspondingly provided with a timer module for coordinately working with the time switch.

The present invention is characterized in that the fan includes a command receiving control unit wirelessly linkable to any type of portable mobile device. When a user operates on the touch-type operation control interface of the portable mobile device, a control command is generated by the portable mobile device for driving the fan to blow air or to oscillate while blowing air. In this manner, the user can still conveniently control and use the fan even if the fan is mounted on a place that could not be easily accessed, such as a higher position or a corner. Therefore, the fan can have largely increased practicality and usability.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a perspective view of fan control system according to a first preferred embodiment of the present invention showing a fan and a portable mobile device thereof;

FIG. 2 is a modular view showing the wireless linking between the portable mobile device and the fan of FIG. 1;

FIG. 3 illustrates an operation control interface on the portable mobile device of the present invention before being actuated;

FIG. 4 illustrates the operation control interface on the portable mobile device of the present invention after being actuated;

FIG. 5 is a perspective view of fan control system according to a second preferred embodiment of the present invention; and

FIG. 6 is a perspective view of fan control system according to a third preferred embodiment of the present invention.

### DETAILED DESCRIPTION OF THE PREFERRED EMBODIMENTS

The present invention will now be described with some preferred embodiments thereof and with reference to the accompanying drawings. For the purpose of easy to understand, elements that are the same in the preferred embodiments are denoted by the same reference numerals.

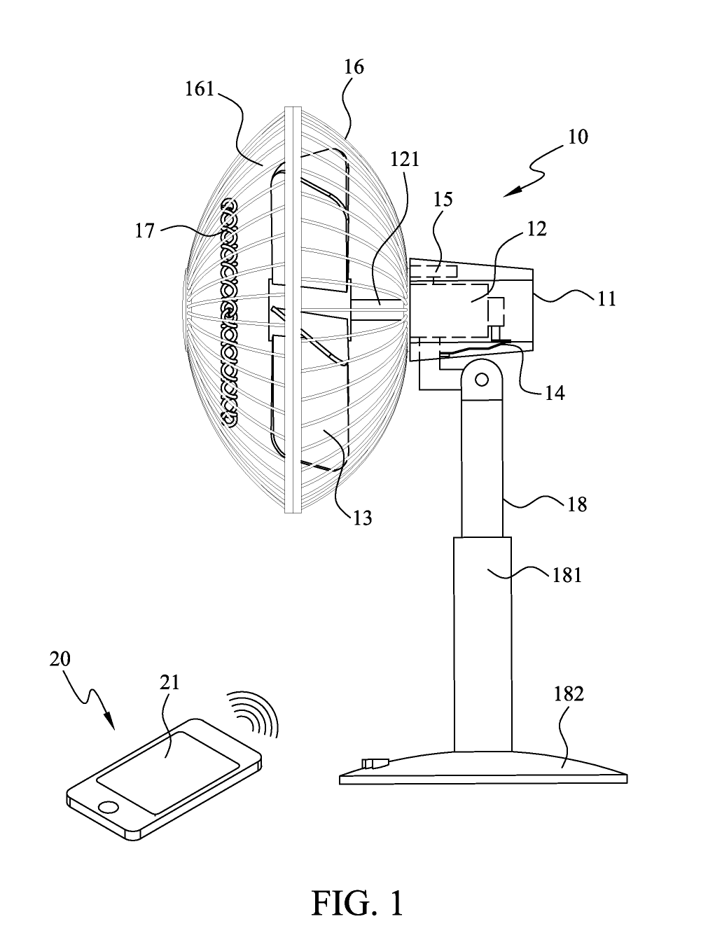

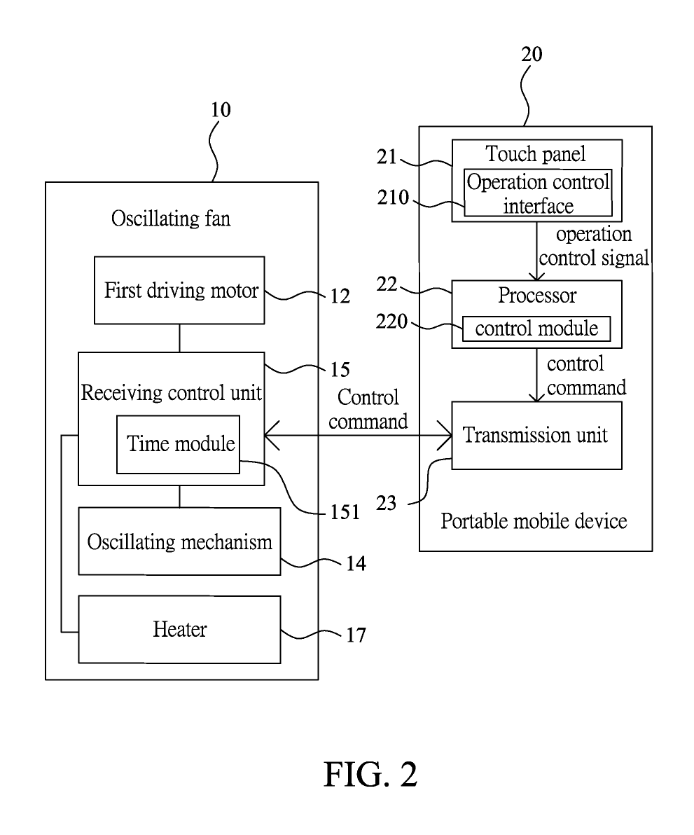

Please refer to FIGS. 1 and 2. A fan control system according to a first preferred embodiment of the present invention includes a fan 10 and a portable mobile device 20 wirelessly linkable to the fan 10. The fan 10 includes a housing member 11, a driving motor 12, a fan blade assembly 13, an oscillating unit 14, a command receiving control unit 15, a hood structure 16, a heater 17 and a stand 18.

The driving motor 12 is mounted inside the housing member 11 and has a forward extended rotary shaft 121 projected from a front outer side of the housing member 11. The fan blade assembly 13 is assembled to the rotary shaft 121. The oscillating unit 14 is also mounted inside the housing member 11 for driving the housing member 11, the driving motor 12 and the fan blade assembly 13 to oscillate as a whole unit. The command receiving control unit 15 is similarly mounted inside the housing member 11 and is electrically connected to the driving motor 12 and the oscillating unit 14.

The hood structure 16 is fixedly connected to the front outer side of the housing member 11 and internally defines a forward protruded oscillating space 161, in which the fan blade assembly 13 is located. The heater 17 is provided in the oscillating space 161 to locate in front of the fan blade assembly 13, and is electrically connected to the command receiving control unit 15. The stand 18 is assembled to a lower side of the housing member 11 for contacting with a floor surface and supporting the fan 10 in an upright position, and mainly includes a stand pole 181 and a base 182. However, it is understood the above-described stand 18 having one single stand pole 181 and a base 182 is only illustrative to facilitate easy description of the fan 10 and not intended to limit the present invention in any way.

The command receiving control unit 15 is electrically connected to the driving motor 12, the oscillating unit 14 and the heater 17; and mainly functions to receive an external control command for actuating the driving motor 12 to operate and produce air flows, or actuating the oscillating unit 14 to change the produced air flows to different blowing directions, or actuating the heater 17 to raise the temperature of the blown-out air flows.

As can be seen from FIGS. 1 and 2, the portable mobile device 20 of the present invention is provided on a surface with a touch panel 21, which forms an operation control interface 210, and is internally provided with a processor 22 and a transmission unit 23. The transmission unit 23 is wirelessly linkable to the command receiving control unit 15. The processor 22 has a control module 220 and is electrically connected to the touch panel 21 and the transmission unit 23.

An operation control signal is generated when a user touches the operation control interface 210 on the portable mobile device 20. The processor 22 receives the operation control signal and correspondingly generates a control command to the transmission unit 23, from where the control command is wirelessly transmitted to the command receiving control unit 15 in the fan 10. In the present invention, the transmission unit 23 and the command receiving control unit 15 can link to each other via a wireless communication protocol, such as Bluetooth, Wi-Fi or WIMAX.

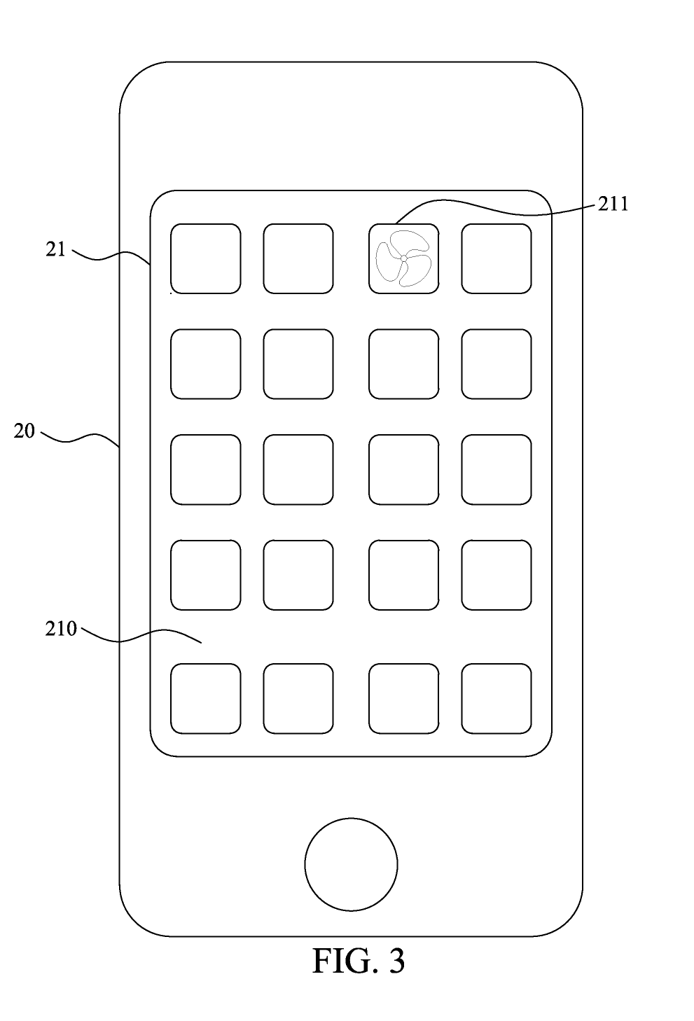

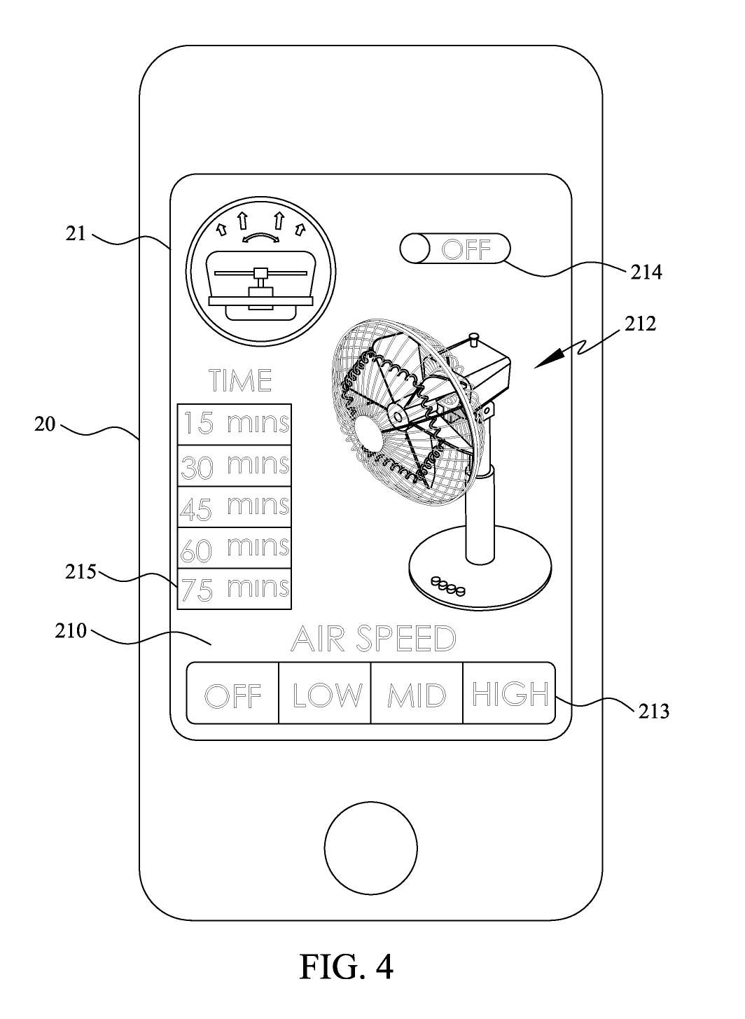

FIGS. 3 and 4 illustrate the operation control interface 210 on the portable mobile device 20 of the present invention before and after being actuated, respectively. The control module 220 of the processor 22 selectively enables the operation control interface 210 to show an actuation icon 211 before actuation or an operation page 212 after actuation. On the operation page 212, there are shown at least an air speed regulation switch 213 for driving the driving motor 12 to operate and an oscillation control switch 214 for driving the oscillating unit 14 to operate and oscillate.

On the operation page 212, there is further shown a time switch 215 for turning on or off the driving motor 12. Meanwhile, the command receiving control unit 15 in the fan 10 is correspondingly provided with a timer module 151 (see FIG. 2), which coordinately works with the time switch 215.

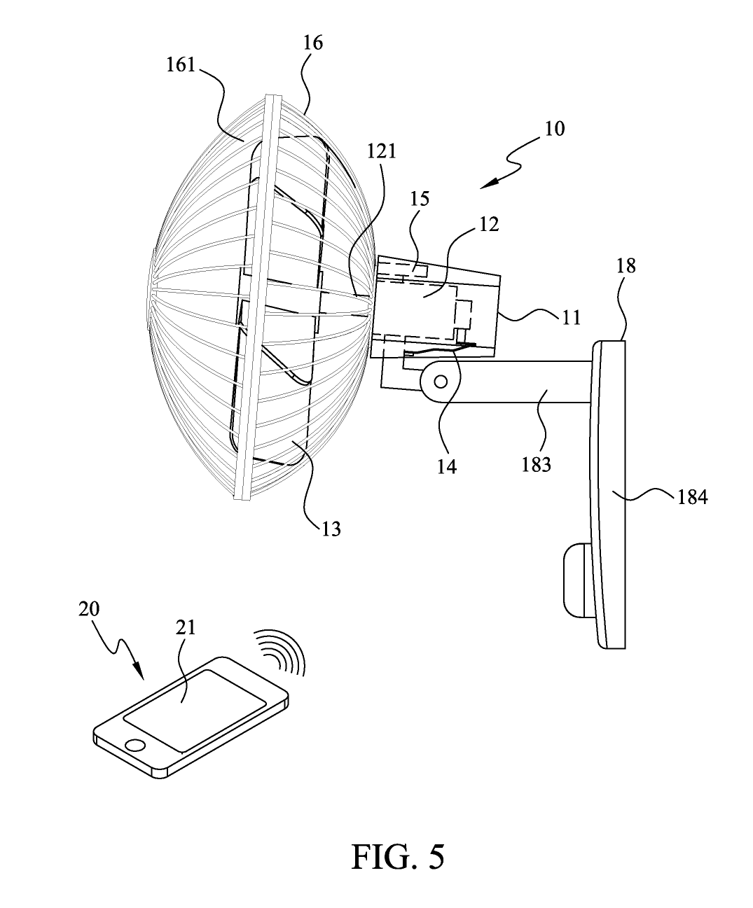

Please refer to FIG. 5, which is a perspective view showing a fan control system according to a second preferred embodiment of the present invention. As shown, the second preferred embodiment of the present invention also includes a fan 10 and a portable mobile device 20. The fan 10 includes a housing member 11, a driving motor 12, a fan blade assembly 13, an oscillating unit 14, a command receiving control unit 15, a hood structure 16 and a stand 18. Except for the stand 18 thereof, the fan 10 in the second preferred embodiment is generally structurally similar to the first preferred embodiment. The stand 18 in the second preferred embodiment is also assembled to the lower side of the housing member 11 but includes a horizontally extended stand pole 183 and a vertically arranged base 184, enabling the fan 10 to be fixedly mounted on a wall surface and function like a wall-mount fan.

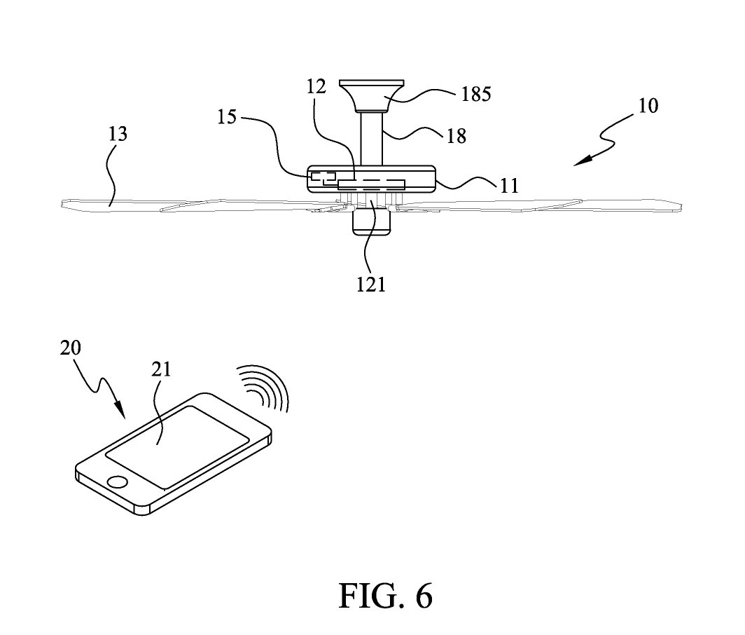

FIG. 6 shows a fan control system according to a third preferred embodiment of the present invention. As shown, the third preferred embodiment of the present invention also includes a fan 10 and a portable mobile device 20. The fan 10 includes a housing member 11, a driving motor 12, a fan blade assembly 13, a command receiving control unit 15 and a stand 18. The fan 10 in the third preferred embodiment is different from the first and the second preferred embodiment in that it does not include the oscillating unit 14 and the hood structure 16, and the stand 18 thereof is assembled to an upper side of the housing member 11 and includes a suspension pole 185 for fixedly mounting to a ceiling, enabling the fan 10 to function like a ceiling fan.

The portable mobile devices 20 for the second and the third preferred embodiment of the present invention are structurally identical to that for the first preferred embodiment and are therefore not repeatedly described herein.

In the present invention, a fan with or without an oscillating unit can be wirelessly controlled with a portable mobile device, so that a user may control the operation of the fan directly with the wireless linking ability of the portable mobile device. Therefore, the fan can be mounted to a position that is not easily accessible by the user to largely increase the practicality and usability of the fan.

The present invention has been described with some preferred embodiments thereof and it is understood that many changes and modifications in the described embodiments can be carried out without departing from the scope and the spirit of the invention that is intended to be limited only by the appended claims.

What is claimed is:

1. A fan control system, comprising:
a fan having a housing member; a driving motor mounted inside the housing member and having a forward extended rotary shaft projected from a front outer side of the housing member; a fan blade assembly assembled to the rotary shaft of the driving motor; and a command receiving control unit mounted inside the housing member and electrically connected to the driving motor; and
a portable mobile device being externally provided on a surface with a touch panel, which forms an operation control interface, and being internally provided with a processor and a transmission unit; the processor internally including a control module and being electrically connected to the touch panel and the transmission unit; and the transmission unit being wirelessly linkable to the command receiving control unit; and
wherein the operation control interface produces an operation control signal when being touched by a user, and the processor receives the operation control signal and correspondingly generates a control command to the transmission unit, from where the control command is wirelessly transmitted to the command receiving control unit in the fan.

2. The fan control system as claimed in claim 1, wherein the transmission unit and the command receiving control unit are linked to each other via a wireless communication protocol selected from the group consisting of Bluetooth, Wi-Fi and WIMAX.

3. The fan control system as claimed in claim 1, wherein the control module selectively enables the operation control interface to show one of an actuation icon before actuation and an operation page after actuation.

4. The fan control system as claimed in claim 3, wherein, on the operation page, there are shown at least an air speed regulation switch for actuating the driving motor to operate.

5. The fan control system as claimed in claim 4, wherein the operation page further has a time switch shown thereon for turning on or off the driving motor, and the command receiving control unit in the fan is correspondingly provided with a timer module for coordinately working with the time switch.

6. The fan control system as claimed in claim 1, wherein the fan further has an oscillating unit mounted inside the housing member and electrically connected to the command receiving control unit for driving the housing member, the driving motor and the fan blade assembly to oscillate as a whole unit.

7. The fan control system as claimed in claim 1, wherein the fan further includes a hood structure, the hood structure being fixedly connected to the front outer side of the housing member and internally defining a forward protruded oscillating space, in which the fan blade assembly is located.

8. The fan control system as claimed in claim 7, wherein the fan further has a heater provided in the oscillating space, and the heater being electrically connected to the command receiving control unit.
